(19) United States
(12) Patent Application Publication
(10) Pub. No.: US 2023/0010128 A1
(43) Pub. Date: Jan. 12, 2023

(54) METHOD OF COLLECTING RARE EARTH ELEMENTS

(71) Applicant: Anita See, Fullerton, CA (US)

(72) Inventors: Michael J. SNYDER, Twentyynine Palms, CA (US); Jack R. See, Fullerton, CA (US)

(21) Appl. No.: 17/861,201

(22) Filed: Jul. 9, 2022

Related U.S. Application Data
(60) Provisional application No. 63/220,256, filed on Jul. 9, 2021.

(51) Int. Cl. C22B 59/00; C22B 1/00; C22B 3/44; C22B 3/16

(52) U.S. Cl. CPC C22B 59/00; C22B 1/005; C22B 3/44; C22B 3/165

(57) ABSTRACT

The present invention provides an environmentally safe method of collecting rare earth elements from mineral sources such as bastnasite deposits. The invention uses calcium hydroxide to decompose rare earth element minerals and avoids the use of sulfuric acid decomposition which produces toxic hydrofluoric acid as a byproduct. The invention's use of calcium hydroxide produces calcium fluoride as a byproduct which is non-toxic and has a number of industrial uses. The invention further provides a method of separating mixed rare earth element leachates into heavy and light rare earth element fractions using inorganic sodium salts as a precipitation agent.

### CROSS REFERENCE TO RELATED APPLICATIONS

This application claims the benefit of provisional application No. 63/220,256 filed Jul. 9, 2021, the entire contents of which are incorporated herein by reference for all purposes.

### FIELD OF THE INVENTION

The invention is in the field of mining and processing mined materials.

### BACKGROUND OF THE INVENTION

Rare earth elements (REE) have great value and are required for the manufacture of a wide variety of products and devices, such as consumer electronics and military weaponry. REE occur in relatively small amounts in mineral deposits. Moreover, these mineral deposits are scarce. Thus, it is critical that the process for mining, collecting, and separating REE from one another be as efficient as possible due to their overall scarcity.

Sulfuric acid baking is the current method by which REEs are separated from their mineral sources. This method is practiced by subjecting a mineral containing REEs to sulfuric acid at high temperatures to decompose the minerals into rare earth element sulfates. The rare earth element sulfates are water soluble and are subsequently collected in a water leach and subjected to purification. While the sulfuric acid baking method can effectively collect REEs from mineral deposits, the method produces hydrofluoric acid as a byproduct, particularly when used to collect REEs from bastnasite mineral deposits. Hydrofluoric acid is toxic and presents a severe environmental hazard, particularly due to the fact that sulfuric acid baking is conducted on an industrial scale in the collection of REEs for commercial use.

The sulfuric acid baking method also lacks efficiency because it yields mixed REEs which require further, costly steps to separate individual REEs from one another. For example, leaching REEs from a sulfuric acid bake yields a mixed REE solution that requires ionic separation and other processes in order to isolate individual REEs that are suitable for industrial use.

What is needed in the art therefore is an environmentally safe method for collecting REEs from mineral deposits on an industrial scale. Also needed in the art is an improvement in the efficiency of separating REEs from one another during their industrial collection from mineral deposits.

### SUMMARY OF THE INVENTION

The invention provides an environmentally safe method for collecting REEs from mineral deposits on an industrial scale by eliminating the need for sulfuric acid baking in the decomposition of REE-bearing materials. The invention improves the efficiency of collecting REEs through a unique precipitation step following decomposition of REE-bearing materials.

In some aspects, the invention provides an environmentally safe method of collecting REEs from an REE-bearing material, wherein the REE-bearing material is decomposed using calcium hydroxide in place of decomposing the REE-bearing material with sulfuric acid.

In another aspect, the invention improves the efficiency of separating REEs from one another in a leachate of a decomposed REE-bearing material by precipitating REEs in the leachate using an inorganic sodium salt to produce a precipitate and a solution, wherein the precipitate comprises a fraction of REEs that are rich in light REEs and the solution comprises a fraction of REEs that are rich in heavy REEs.

### BRIEF DESCRIPTION OF THE DRAWINGS

FIG. 1 is a process diagram showing steps for mine ore concentration for use with an embodiment of the inventive method.

FIG. 2 is a process diagram showing steps for decomposition of an ore concentrate.

FIG. 3 is a process diagram showing steps for ion exchange and solvent extraction of contaminants from a leachate.

FIG. 4 is a process diagram showing steps for REE separation for use with an embodiment of the inventive method.

FIG. 5 is a process diagram showing an embodiment of a method of the invention that comprises salt precipitation of a leachate.

### DEFINITIONS

“Rare earth elements” and “REEs” are used interchangeably herein in singular and plural form to refer to any of the rare earth elements (including scandium and yttrium) in their elemental metal or oxide forms.

“Heavy rare earth elements,” “heavy REEs,” and “HREEs” are used interchangeably herein in singular and plural form to refer to any of the heavy rare earth elements in their elemental metal or oxide forms, and include cerium, lanthanum, neodymium, praseodymium, samarium, and promethium.

“Light rare earth elements,” “light REEs”, and “LREEs” are used interchangeably herein in singular and plural form to refer to any of the heavy rare earth elements in their elemental metal or oxide forms, and include dysprosium, erbium, europium, gadolinium, holmium, lutetium, terbium, thulium, yttrium, ytterbium, and scandium.

### DETAILED DESCRIPTION

The invention provides an environmentally safe method for the collection of REEs from REE-bearing materials on an industrial scale. In some embodiments, the method substitutes the decomposition of REE-containing ores and minerals using sulfuric acid baking with calcium hydroxide baking. By substituting sulfuric acid baking with calcium hydroxide baking, the inventive method avoids the production of toxic hydrofluoric acid that typifies known methods of collecting REEs on an industrial scale. Rather, the inventive method produces calcium fluoride as a byproduct of the decomposition of minerals and ores containing REEs. Calcium fluoride is not only non-toxic, it is also useful in a number of industrial applications, including the manufacture of optical components. Thus, the inventive method collects REE from ores and minerals on an industrial scale without creating an environmental hazard while producing a non-toxic, useful byproduct.

In some embodiments, the inventive method comprises treating an REE-bearing material with calcium hydroxide. The REE-bearing material can be treated with calcium hydroxide by contacting the REE-bearing material with calcium hydroxide, such as by mixing, stirring, folding, or shaking. The REE-bearing material can be treated with calcium hydroxide at a temperature that is sufficient to decompose REE minerals within the material. Suitable temperatures for treating the REE-bearing material with calcium hydroxide include, but are not limited to, at least about 350 degrees C., at least about 450 degrees C., at least about 550 degrees C., at least about 650 degrees C., and at least about 750 degrees C. The temperature for decomposing the REE-bearing material can be between about 350 degrees C. and about 750 degrees C. In other embodiments, the REE-bearing material can be decomposed with calcium hydroxide at a temperature of between about 350 degrees C. and about 450 degrees C., between about 450 degrees C. and about 550 degrees C., between about 550 degrees C. and about 650 degrees C., or between about 650 degrees C. and about 750 degrees C. The REE-bearing material can be treated with calcium hydroxide at 20% w/w relative to the REE-bearing material.

Following decomposition with calcium hydroxide, the decomposed REE-bearing material can be treated with a leaching agent to produce a mixed REE leachate that contains a mixture of REEs. In a preferred embodiment, the decomposed REE-bearing material is leached with an organic acid. Suitable organic acids for leaching the decomposed REE-bearing material include, but are not necessarily limited to, tartaric acid, lactic acid, citric acid, malonic acid, succinic acid, carboxylic acid, and mixtures thereof. The mixed REE leachate can be treated with the at least one organic acid in an amount such that the at least one organic acid comprises 5% of the combined leachate/acid solution. In a preferred embodiment, the at least one organic acid includes tartaric acid.

Following leaching of the decomposed REE-bearing material with organic acid, the mixed REE leachate can be precipitated using an inorganic sodium salt. By precipitating the mixed REE leachate with an inorganic sodium salt, the invention separates the mixed REE leachate into a precipitate fraction containing light REEs, and a solution fraction containing heavy REEs. Separating the mixed REE leachate into heavy and light fractions of REEs greatly improves the efficiency the downstream purifying of individual light and heavy REEs using processes such as ion exchange chromatography, for example.

It will be appreciated by one skilled in the art that inorganic sodium salt precipitation can be used to precipitate mixed REE leachates that are produced by other methods of decomposition and leaching, such as sulfuric acid baking and water leaching, for example. That is, the invention contemplates using at least one inorganic sodium salt to precipitate mixed REE leachates produced by decomposition methods such as sulfuric acid baking and water leaching, wherein precipitating the leachate with the at least one inorganic sodium salt separates the leachate into a precipitate fraction containing light REEs, and a solution fraction containing heavy REEs.

In a preferred embodiment, mixed REE leachates, whether resulting from calcium hydroxide decomposition and leaching, or another method of decomposition and leaching, are precipitated by treating the leachate with one or more inorganic sodium salts. The leachate can be treated with the at least one inorganic sodium salt by contacting the leachate with one or more inorganic sodium salts under conditions sufficient to create a precipitate fraction containing light REEs, and a solution fraction containing heavy REEs. Suitable inorganic sodium salts for precipitating mixed REE leachates according to the invention include, but are not necessarily limited to, sodium chloride, sodium fluoride, sodium bromide, sodium iodide, sodium sulfate, sodium bicarbonate, sodium carbonate, sodium amide, or mixtures thereof. In a preferred embodiment, mixed REE leachates are treated with sodium chloride.

The precipitate fraction containing light REEs can be subjected to suitable procedures for purifying individual light REEs from the fraction, such as, for example, ion exchange chromatography. The precipitate fraction containing light REEs can be purified by ion exchange chromatography for one or more of cerium, lanthanum, neodymium, praseodymium, samarium, and promethium. The solution fraction containing heavy REEs can similarly be subjected to ion exchange chromatography, or other suitable procedure, for purifying one or more heavy REEs from the solution fraction. The solution fraction containing heavy REEs can be purified for one or more of dysprosium, erbium, europium, gadolinium, holmium, lutetium, terbium, thulium, yttrium, ytterbium, and scandium.

In some embodiments of the invention, cerium is removed from the precipitate fraction containing light REEs. The removal of cerium from the precipitate fraction containing light REEs offers the advantage of simplifying the purification of other light REEs from the fraction, as well as purifying cerium itself. Cerium can be removed from the precipitate fraction containing light REEs by calcinating the precipitate at high temperature, such as 1200 degrees F., so as to make cerium in the precipitate insoluble in a hydrochloric acid while the remaining light REEs in the precipitate remain soluble in hydrochloric acid. The calcined precipitate is then placed in a solution of hydrochloric acid so as to precipitate and filter out the insoluble cerium. The filtrate can then be processed for purification of individual REEs, such as by ion exchange chromatography.

The invention can be practiced to collect REEs from any REE-bearing material that contains REEs, REE minerals, or a combination thereof. The invention can be practiced to collect REEs from REE-bearing materials including, but not necessarily limited to, ores, mine tailings, soil, smelter waste, igneous rock, alkaline rock, carbonatites, mine waste, placer material, topsoil, coal, crushed rock, sediments, or combinations thereof. The REE-bearing material can contain one or more REE minerals such as, for example, bastnasite, monazite, allanite, loparite, ancylite, parisite, lanthanite, chevkinite, cerite, stillwellite, britholite, fluocerite, cerianite, gadolinite, xenotime, samarskite, euxenite, fergusonite, yttrotantalite, yttrotungstite, yttrofluorite, thalenite, yttrialite, or combinations thereof. In a preferred embodiment, the REE-bearing material is an ore comprising bastnasite.

In some embodiments of the invention, the REE-bearing material is concentrated for REEs, or REE minerals, prior to decomposing the REE-bearing material. That is, the REE-bearing material is concentrated for REEs or REE containing minerals prior to decomposition by calcium hydroxide or other decomposition method, such as sulfuric acid baking. The REE-bearing material can be concentrated for REE or REE minerals using dry air concentration, for example. Suitable systems, apparatuses, and methods for performing dry air concentration in connection with the invention include, but are not necessarily limited to, those disclosed in U.S. Pat. Nos. 4,451,357 and 9,682,405, the entire contents of which are incorporated herein by reference for all purposes.

In some embodiments, the REE-bearing material is screened and/or ground prior to dry air concentration. The REE-bearing material can be screened such that material having a size of about 10 mesh or smaller, or about 100 mesh or smaller, is subjected to dry air concentration. REE-bearing material that is larger than about 10 mesh, or larger than about 100 mesh, can be ground to a size of about 10 mesh or about 100 mesh and then subjected to dry air concentration. In other embodiments, the REE-bearing material is screened and/or ground such that material having a size that is about 10 mesh or smaller, or about 100 mesh or smaller, is decomposed without being subjected to dry air concentration.

In some embodiments, the particle size of the REEs and REE minerals in the REE-bearing material being subjected to dry air concentration is monitored in real-time so as to optimize the concentration of the REEs and REE minerals. Crushing REE-bearing materials can reduce the particle size of the REEs and REE minerals in the material to micron size. Thus, identifying the size of the particles containing the REEs and REE minerals prior to concentration can identify the target size of the particles to be collected by dry air concentration. In practice, the size range of the REEs and REE minerals in the REE-bearing material to be concentrated is determined. The particle size of the accumulating concentrate is then monitored during dry air concentration and the concentrate is collected when an acceptable amount of the target size particle has accumulated in the concentrate thereby improving the efficiency of the collection of REEs and REE minerals by dry air concentration. Similarly, the target particle size can be monitored in real-time so as to adjust the operating parameters of the dry air concentrator, such as the dry air concentrator's belt speed, belt angle, and air pressure. Suitable devices for monitoring the particle size of REEs and REE minerals in REE-bearing materials include, but are not necessarily limited to, the nCS1™ particle analyzer available from Spectradyne™.

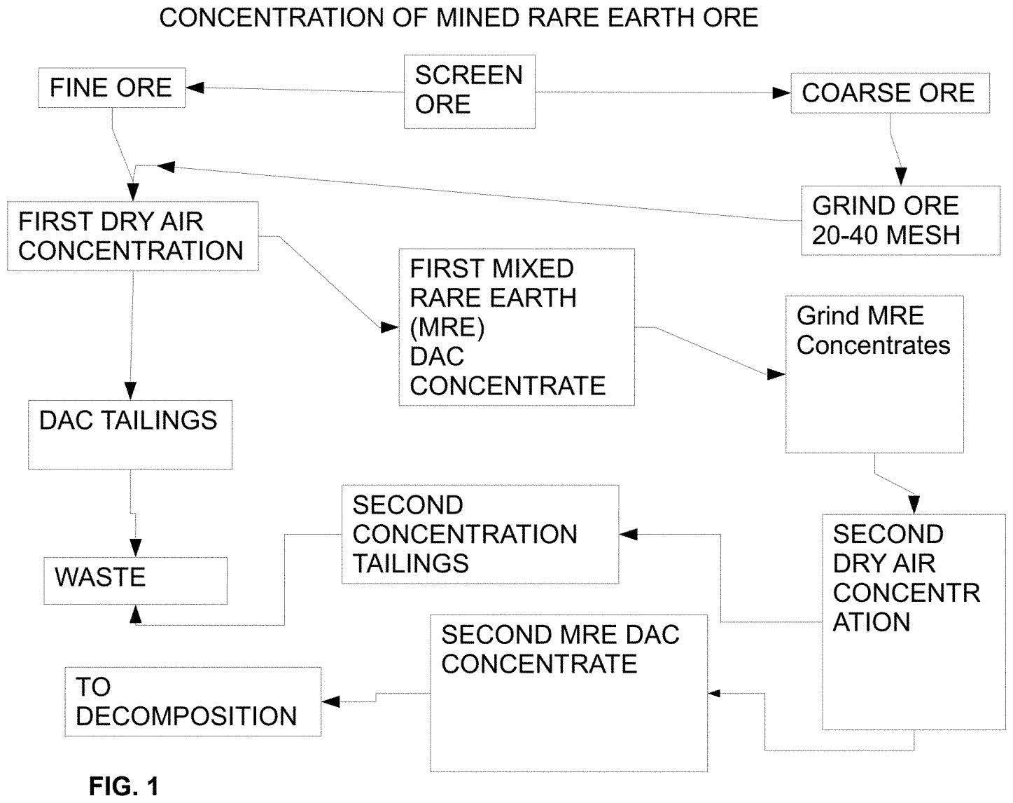

FIGS. 1-4 show flowcharts depicting a non-limiting embodiment of the inventive method of collecting heavy minerals from an REE-bearing materials. FIG. 1 shows steps for concentrating a REE-bearing material comprising screening, grinding, and subjecting the REE-bearing material to dry air concentration. It will be appreciated that the steps disclosed in FIG. 1 can be practiced to prepare an REE-bearing material for decomposition by calcium hydroxide as disclosed herein, and other methods of decomposition, such as sulfuric acid baking.

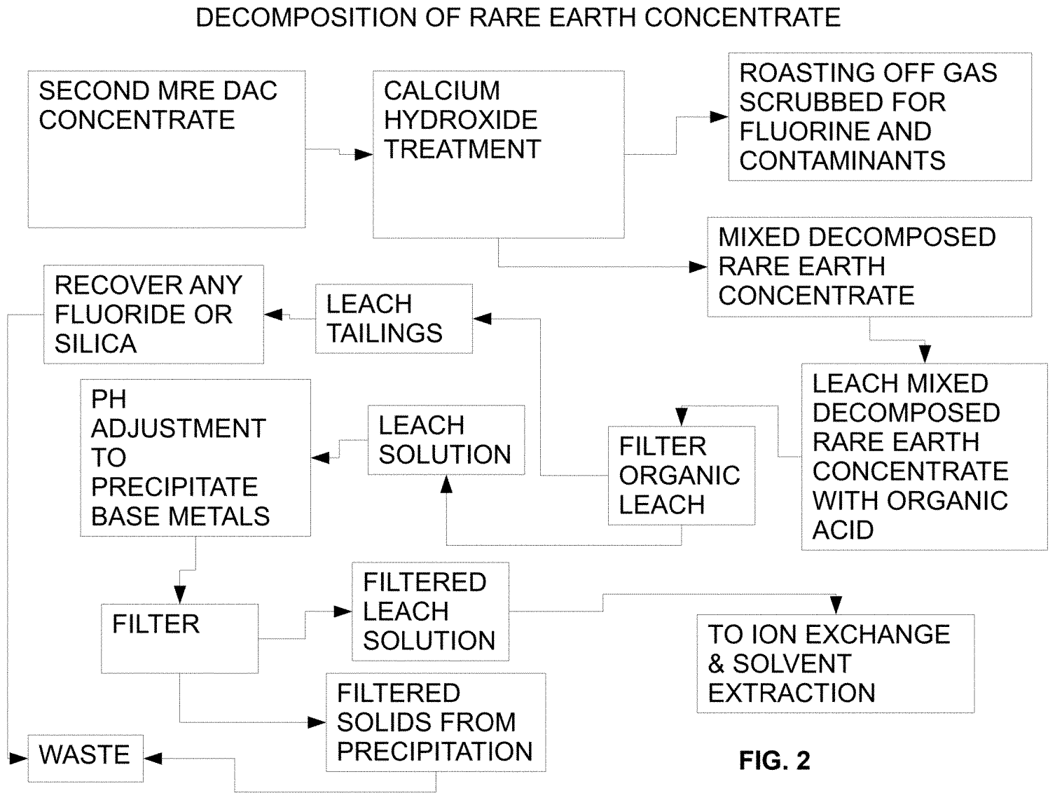

FIG. 2 shows steps for decomposing REE-bearing material that is concentrated according to the steps of FIG. 1. The steps include treating the concentrated REE-bearing material with calcium hydroxide under conditions sufficient to decompose the material. Treating the concentrated REE-bearing material with calcium hydroxide can be done under heat and in an amount as disclosed herein. FIG. 2 further shows the step of leaching the decomposed material with organic acid, filtering the leachate, and precipitating and filtering out base metals from the leachate solution. It will be appreciated that one or more of the steps depicted in FIG. 2 may optionally be omitted. For example, the leachate may proceed to ion exchange and solvent extraction without the step of pH adjustment to precipitate and filter out base metals.

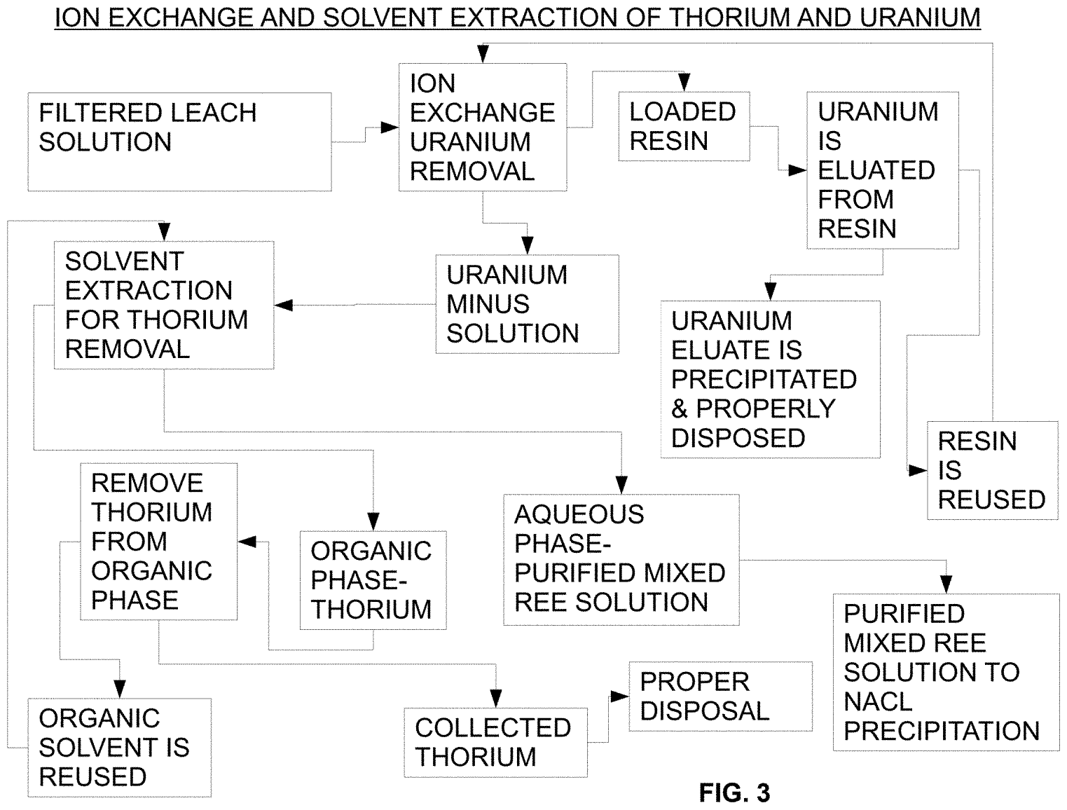

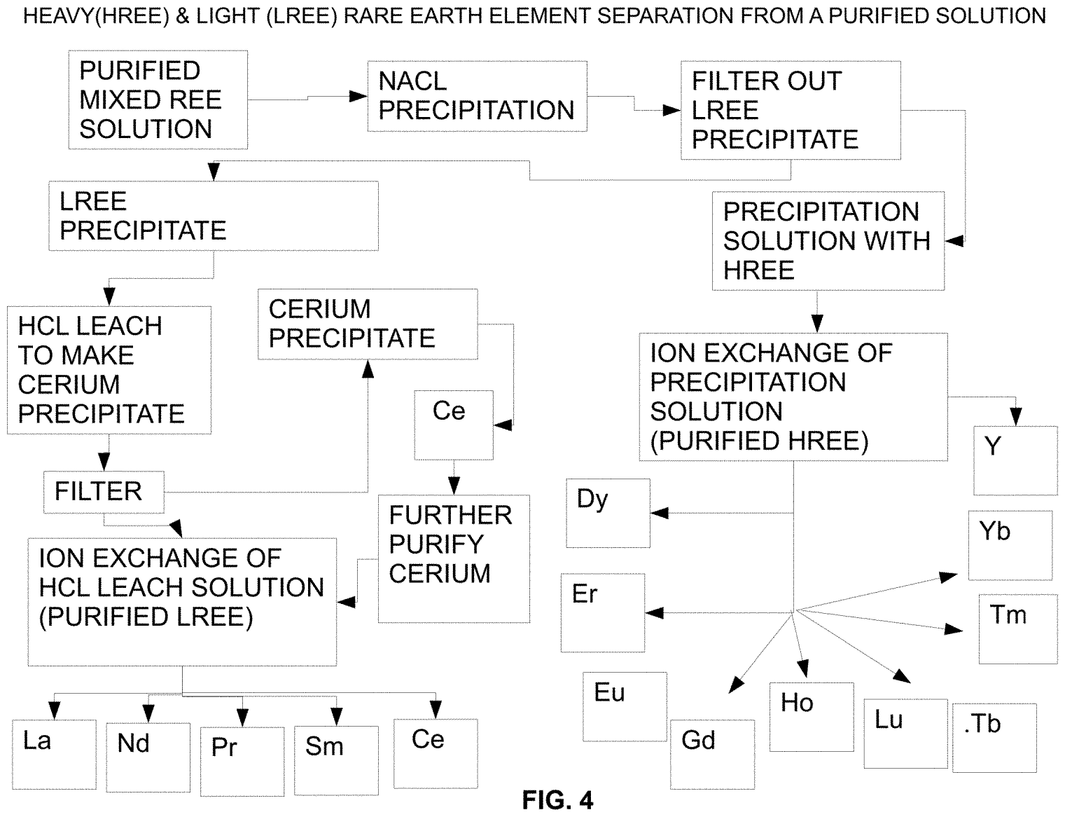

FIG. 3 shows steps for ion exchange and solvent extraction of thorium and uranium from the leachate produced in FIG. 2. While FIG. 3 depicts ion exchange and solvent extraction of a leachate produced from calcium hydroxide decomposition and organic acid leaching, it will be appreciated that the steps disclosed in FIG. 3 may be practiced to remove thorium and uranium from a leachate produced by other methods of decomposing and leaching an REE-bearing material, such as sulfuric acid baking and water leaching. It will also be appreciated that the steps depicted in FIG. 3 may be omitted such that the leachate produced by one or more of the steps of FIG. 2 can proceed directly to the process disclosed in FIG. 4.

FIG. 4 shows steps for separating the mixed REE solution from FIG. 2, or FIG. 3, into light REE and heavy REE fractions, and purifying the fractions for individual REEs. While FIG. 4 discloses that the mixed REE solution is precipitated with sodium chloride, it will be appreciated that the mixed REE solution can be precipitated using one or more inorganic sodium salts, including sodium chloride. For example, the mixed REE solution can be precipitated using one or more of sodium chloride, sodium fluoride, sodium bromide, sodium iodide, sodium sulfate, sodium bicarbonate, sodium carbonate, and sodium amide.

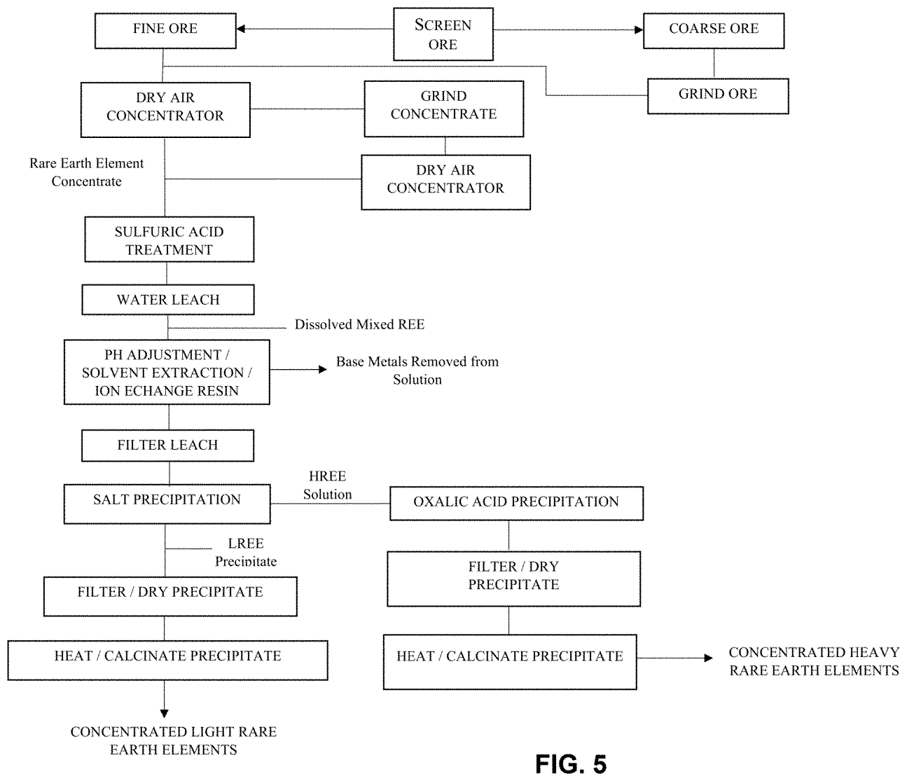

FIG. 5 shows a non-limiting embodiment of a method of collecting REEs from an REE bearing material using sulfuric acid baking. The method can comprise the steps of screening and grinding an ore, and subjecting the screened, ground ore to dry air concentration. The concentrated ground ore is subsequently subjected to sulfuric acid treatment to decompose the ore by sulfuric acid baking at a high temperature, such as between about 200 degrees C. and about 500 degrees C. The method can further comprise the steps of leaching the decomposed ore material, and precipitating the leachate with an inorganic sodium salt to produce a precipitate fraction containing light REE, and a solution fraction containing heavy REE. The solution fraction can be subjected to oxalic acid precipitation, filtration, and calcination to produce a concentrate of heavy REEs. The precipitate fraction of light REEs can similarly be filtered and calcinated to produce a concentrate of light REEs. The light and heavy REE concentrates may then be subjected to processes to purify individual REEs, such as solvent extraction and/or ion exchange chromatography, for example.

In view of the above, it will be seen that several advantages may be achieved and other advantageous results may be obtained. Various changes could be made in the above apparatuses and methods without departing from the scope of the present disclosure.

The following example is set forth as representative of the present invention. This example is not to be construed as limiting the scope of the invention other equivalent embodiments will be apparent in view of the present disclosure and appended claims.

### Example 1— Sulfuric Acid Decomposition and Inorganic Sodium Salt Precipitation

1. The ore comprised a mixed Rare Earth Bastnasite (fluorocarbonate), containing 14 REE, including a small amount of Y and Sc.
2. The ore is mined.
3. The ore (2) can be crushed in rock crusher if desired.
4. Ore (2,3) is screened to 10 mesh which produces a mean minus −10 mesh and an oversize mean plus +10 mesh particle size.
5. The plus 10 mesh fraction requires grinding to liberate and concentrate the target mineral bastnasite. Grind would be −40 to −60 mesh in a vertical shaft impactor.
6. The −10 mesh can be processed “as is” by a dry concentrator (DAC).
7. The −10 mesh or ground +10 mesh is processed through the dry concentrator and produces a 30-35 to 1 ratio of concentration.
8. The DAC concentrate (7) is then ground to −100 mesh & further reprocessed by DAC to remove the unwanted or gangue material/mineral present in the concentrate.
9. Approximately ⅔ of the gangue minerals are removed during the reprocessing (8) resulting in a final Bastnasite concentrate which has been concentrated approximately 90 to 1 at this point.
10. Final Concentrate (9) is mixed with sulfuric acid at a rate of 15% weight of sulfuric to ore (by Weight). Example: 100 grams of ore would be 15 grams or 8.15 mls of sulfuric acid.
11. In our testing the sulfuric acid was diluted with distilled water at a rate of 1 to 1. (Example 8 mls of sulfuric and 8 mls of water).
12. The sulfuric acid mixture and concentrates are mixed together to form a paste.
13. The paste is then baked at 375 degrees F. for 4 hours.
14. The baked material (13) is then placed in water at a 10% density of solids to liquid.
15. The water baked material (14) is then heated in a suitable vessel to 90 degrees C. and held at this temperature for 6-24 hours.
16. The water leach is then filtered, separating the solids (tailings) from the solution (pregnant solution).
17. The pregnant solution (16) is then brought to ambient temperature and precipitated with NaCL 5-10 g per liter. This produces a milky white precipitate (Rare Earth Chloride) of light REE and a heavy REE solution.
18. The precipitate from 17 is filtered and dried.
19. The precipitate from 18 is calcined (brought to temp of 1400 degrees F. for 60 min) converting the precipitate to an oxide.
20. The precipitate from 17-19 will be mostly light Rare Earth (LREE) portion of the combined mixed REE (present in the ore) dissolved from the processing of the DAC concentrate.
21. The solution from 17 is then precipitated with oxalic acid C₂H₂O₄ to produce a mixed mostly Heavy Rare Earth Oxalate. The REE oxalate (HREE) is filtered, dried and calcined to convert to Rare Earth oxide.

1. A method of separating heavy rare earth elements from light rare earth elements, comprising:
a) providing an ore containing rare earth elements;
b) producing a treated ore by treating said ore with at least one acid, calcium hydroxide, or a combination thereof; and
c) leaching said treated ore with at least one leaching agent to produce a first solution containing at least a portion of said rare earth elements; and
d) treating said first solution with at least one salt thereby producing (i) a second solution, and (ii) a first precipitate, wherein said second solution contains a greater amount of heavy rare earth elements than said first precipitate.

2. The method of claim 1, wherein said at least one acid comprises sulfuric acid and said at least one leaching agent comprises water.

3. The method of claim 1, wherein said ore is treated with calcium hydroxide, and said at least one leaching agent comprises an organic acid.

4. The method of claim 3, wherein said organic acid comprises an organic acid selected from the group consisting of tartaric acid, lactic acid, citric acid, malonic acid, succinic acid, carboxylic acid, and mixtures thereof.

5. The method of claim 1, wherein said at least one salt comprises at least one inorganic sodium salt.

6. The method of claim 5, wherein said inorganic sodium salt comprises an inorganic sodium salt selected from the group consisting of sodium chloride, sodium fluoride, sodium bromide, sodium iodide, sodium sulfate, sodium bicarbonate, sodium carbonate, sodium amide, and mixtures thereof.

7. The method of claim 1, further comprising producing a rare earth element ore concentrate by concentrating said ore for rare earth elements with a dry air concentrator prior to treating step 1(b).

8. The method of claim 7, wherein said rare earth element ore concentrate is ground to a mean particle size of up to about 100 mesh.

9. The method of claim 1, wherein said ore comprises a mineral selected from the group consisting of bastnasite, monazite, xenotime, and mixtures thereof.

10. The method of claim 1, wherein said ore comprises at least one mineral selected from the group consisting of rare earth element fluorocarbonates, rare earth element phosphates, and mixtures thereof.

11. The method of claim 1, further comprising removing contaminants from said first solution by subjecting said first solution to at least one of: (i) an increase in pH, (ii) solvent extraction, and (iii) at least one ion exchange resin.

12. The method of claim 11, wherein said removing step is performed prior to treating said first solution with said at least one salt.

13. The method of claim 1, further comprising filtering, drying, and calcinating said first precipitate thereby producing a light rare earth element calcinate.

14. The method of claim 13, wherein said light rare earth element calcinate comprises light rare earth oxides.

15. The method of claim 13, further comprising treating said light rare earth element calcinate with hydrochloric acid thereby producing a cerium precipitate and a solution that is substantially free of cerium, and removing said cerium precipitate from said solution that is substantially free of cerium.

16. The method of claim 1, wherein said second solution is: (i) treated with oxalic acid to produce a second precipitate that contains heavy rare earth elements in an amount that is greater than the amount of heavy rare earth elements present in said first precipitate; or (ii) subjected to at least one ion exchange resin thereby isolating at least one heavy rare earth element.

17. The method of claim 16, further comprising filtering, drying, and calcinating said second precipitate.

18. The method of claim 17, further comprising filtering, drying, and calcinating said at least one isolated heavy rare earth element.

19. The method of claim 16, wherein said second precipitate comprises heavy rare earth element oxides.

20. An environmentally safe method of separating heavy rare earth elements from light rare earth elements, comprising:
a) providing an ore containing rare earth elements;
b) treating said ore with calcium hydroxide to produce a treated ore;
c) leaching said treated ore with at least one organic acid to produce a first solution, wherein said at least one organic acid comprises an acid selected from the group consisting of tartaric acid, lactic acid, citric acid, malonic acid, succinic acid, carboxylic acid, and mixtures thereof;
d) removing contaminants from said first solution by subjecting said first solution to at least one of (i) an increase in pH, (ii) solvent extraction, and (iii) at least one ion exchange resin, thereby producing a decontaminated solution;
e) treating said decontaminated solution with sodium chloride to produce (i) a second solution, and (ii) a first precipitate, wherein said second solution contains a greater amount of heavy rare earth elements than said first precipitate;
f) filtering, drying and calcinating said first precipitate, thereby producing a light rare earth element calcinate;
g) treating said light rare earth element calcinate with hydrochloric acid to produce a cerium precipitate and a third solution that is substantially free of cerium,
h) removing said cerium precipitate from said third solution.
